(19) United States
(12) Patent Application Publication
(10) Pub. No.: US 2014/0282696 A1
(43) Pub. Date: Sep. 18, 2014

(54) ADVERTISING DOWNLOAD VERIFICATION

(71) Applicant: QUALCOMM Incorporated, San Diego, CA (US)

(72) Inventors: Yinian Mao, San Diego, CA (US); Kevin R. Fall, Bethel Park, PA (US); Fatih Ulupinar, San Diego, CA (US)

(73) Assignee: QUALCOMM Incorporated, San Diego, CA (US)

(21) Appl. No.: 14/050,055

(22) Filed: Oct. 9, 2013

Related U.S. Application Data
(60) Provisional application No. 61/792,454, filed on Mar. 15, 2013.

(51) Int. Cl. G06Q 30/02; H04N 21/2347; H04N 21/81

(52) U.S. Cl. CPC G06Q 30/0248; H04N 21/812; H04N 21/2347
USPC 725/32

(57) ABSTRACT

Methods and systems are described for verifying that advertising content has been downloaded by a client. When a streaming client requests advertising content from an advertising server, the streaming client receives one or more verifiers from the advertising server. The streaming client sends information associated with the verifiers to a media server. The media server is configured to validate streaming of the advertising content to the streaming client based on the information associated with the verifiers.

### CROSS REFERENCE TO RELATED APPLICATIONS

This application claims priority to, and the benefit of, U.S. provisional patent application Ser. No. 61/792,454, filed Mar. 15, 2013 and entitled ADVERTISING DOWNLOAD VERIFICATION, which is incorporated by reference herein in its entirety.

### BACKGROUND

Media such as music and video may be streamed over a network from a server that stores the media content to client software running on a user device such as a personal computer or mobile device. Many providers of media use advertising-supported business models. Advertisers may pay media providers for advertising content provided with media, such as advertising streamed before or intermittently during playback of media content. The advertising content may allow media providers to offer media content to users for free or at a reduced price.

Some users take measures to obtain advertising-supported media while avoiding the advertising content provided with the requested media content. Software applied to a browser or a media playback application may block advertising from being downloaded when media content is delivered. For example, browser plug-ins are used to block advertising content delivered to in-browser media playback applications.

Widespread use of software for blocking, modifying, or substituting alternative content for advertising content can threaten the ability of content providers to continue to develop and provide media content.

### SUMMARY

Methods and systems are described for verifying that advertising content has been downloaded by a client.

In one embodiment, a method is described in which a streaming client requests advertising content from an advertising server. The streaming client receives one or more verifiers from the advertising server. The streaming client sends information associated with the verifiers to a media server. The media server is configured to validate streaming of the advertising content to the streaming client based on the information associated with the verifiers.

In another embodiment, non-transitory computer readable media for storing program code executable by a processor of a client are described. The non-transitory computer readable media include program code for requesting advertising content from an advertising server. The non-transitory computer readable media further include program code for receiving one or more verifiers from the advertising server. The non-transitory computer readable media additionally include program code for sending information associated with the verifiers to a media server. The media server is configured to validate streaming of the advertising content to the streaming client based on information associated with the verifiers.

In a further embodiment, a client device having a memory and a processor coupled to the memory is described. The processor is configured with processor-executable instructions to perform a method comprising requesting advertising content from an advertising server, receiving, from the advertising server, one or more verifiers, and sending, to a media server, information associated with the verifiers, wherein the media server is configured to validate streaming of the advertising content to the streaming client based on the information associated with the verifiers.

In a still further embodiment, a method is described in which streaming media is sent to a streaming client by a media server. Information associated with one or more verifiers is received from the streaming client. The verifiers are associated with advertising content. Streaming of the advertising content to the streaming client is validated based on the information associated with the verifiers. If the validation is unsuccessful, the sending of the streaming media is halted.

### BRIEF DESCRIPTION OF THE DRAWINGS

FIG. 1 shows an illustrative system diagram for a system in which media download verification may occur.

FIG. 2 shows an illustrative sequence diagram indicating communications between an ad server, a media server, and a streaming client according to an embodiment.

FIG. 3 shows illustrative components that may be included in an ad verifier.

FIG. 4 is an illustrative flow diagram for verifying that ad content has been downloaded by a streaming client, according to an embodiment.

FIG. 5 is an illustrative flow diagram for verifying that ad content has been downloaded by a streaming client when a byte range is specified in an ad verifier.

FIG. 6 is an illustrative flow diagram for verifying that ad content has been downloaded by a streaming client with a browser-based media player.

FIG. 7 is an illustrative block diagram of a computer system.

### DETAILED DESCRIPTION

Streaming clients that receive media content from a media server may be modified with software for preventing advertising content associated with the media content from being downloaded. For example, the streaming client may be modified such that the streaming client downloads short duration media from a non-advertising server in lieu of downloading advertising content from the designated advertising server. In order to prevent delivery of media content to streaming clients that are modified to avoid downloading advertising content, one or more advertising verifiers can be generated by an advertising server and sent to a streaming client when advertising content is sent to the streaming client. The streaming client can send information associated with the advertising verifiers to the media server. The media server can use the information received from the streaming client to verify that the streaming client downloaded advertising content from the ad server. The media server may prevent subsequent streaming of media content to the streaming client if the media server is unable to verify that the streaming client downloaded advertising content from the ad server. As used herein, the term “downloading” (such as downloading of advertising content by a streaming client) may indicate streaming (such as streaming of advertising content from the ad server to the streaming client). In some instances, the “advertising content” or “content” may include executable code or instructions that are otherwise interpreted in execution.

FIG. 1 shows an illustrative system diagram 100. Media content may be provided to streaming client 102 from media server 104. The terms “client” and “streaming client” are used interchangeably herein.

Media content may be stored in media content database 106. Media content database 106 may be stored on media server 104 or may be stored on one or more servers communicatively coupled to media server 104. Media content can include video, audio, streaming text, and any other content that can be received over a period of time by streaming client 102, such as live webcast content and stored media content. The terms “media content” and “media” are used interchangeably herein.

Advertising content may be provided to streaming client 102 from an ad server 108. Advertising content may be stored in ad content database 110. Ad content database 110 may be stored on ad server 108 or may be stored on one or more servers communicatively coupled to ad server 108. Advertising content may include video, audio, advertising images and/or text overlaid on media content, or other content. Advertising content may be shown before, after, concurrently with, or interspersed within media content. Typically, media content is content that is requested by a user, for example, by using a user interface of streaming client 102. Advertising content 118 may be content not requested by a user that is provided to streaming client 102 in association with the user-requested media content. The terms “advertising” and “ad” are used interchangeably herein.

Streaming client 102 may be a device configured to provide media playback capabilities. For example, streaming client 102 may be a personal computer; a mobile device such as a cellular phone, media player, tablet, laptop computer; or other device capable of playing streaming media. Streaming client 102 may execute code for playing back media, such as a standalone media playback application 112 or a browser-based media player 114 configured to run in an Internet browser 116.

One or more of streaming client 102, media server 104, ad server 108, media content database 106, ad content database 110 can be located on the same device, such as a server computer. In some embodiments, streaming client 102 receives media content and advertising content via a network, such as network 118. Network 118 may be a wide area network (WAN), local area network (LAN), the Internet, a cellular network, one or more other networks, or a combination thereof.

One or more cryptographic keys (e.g., a shared secret key or a public-private key pair) may be established between the ad server 108 and the media server 104. In one embodiment, ad server 108 will hold the signing key (i.e., the private key of a public-private key pair) and media server 104 hold the verification key (i.e., the public key of a public-private key pair). For example, ad server 108 may generate a shared secret key or public-private key pair and send the shared secret key or public key to media server 104. Ad server 108 may send a key to media server 104 before each streaming session (for example, in response to a request for a key received by ad server 108 from media server 104 each time a streaming session is initiated), before each time ad server 108 sends advertising content to streaming client 102, or at another point in time prior to sending advertising content to streaming client 102. In an embodiment, the ad server 108 may send the key using a secure protocol, e.g., sending the key with a certificate that may be used to authenticate the key.

When streaming client 102 receives advertising content from ad server 108, streaming client 102 may also receive one or more ad verifiers from ad server 108. Ad verifiers may be received by streaming client 102 before, after, or as part of the ad content. Ad verifiers may include information including one or more of an identifier for a particular streaming session, a timestamp, an identifier of a particular streaming client, information indicating a byte range of an ad stream, and a digital signature generated using a key stored by ad server 108. The terms “ad verifier” and “verifier” are used interchangeably herein.

Streaming client 102 can transmit information associated with the ad verifiers to media server 104. Media server 104 may apply the shared secret key or public key to the information received from streaming client 102 in order to verify that streaming client 102 received ad content streamed from ad server 108.

FIG. 2 shows an illustrative sequence diagram 200 indicating communications between an ad server, a media server, and a streaming client according to an embodiment. Streaming client 102 may request media content from media server 104, as indicated at 202. Media server 104 may respond to the request by streaming media content to streaming client 102, as indicated at 204. Media server 104 may signal to streaming client 102 that the streaming client will need to download advertising content, as indicated at 206. In some embodiments, signaling for advertising 206 may occur prior to the request for media content 202 and the streaming of media content 204. Signaling for advertising 206 occurs periodically or at predefined intervals during media content streaming 204. In various embodiments, signaling for advertising 206 may be based on one or more of information contained in media content 204, information sent independently of media content from media server 104 to streaming client 102, or commands of an application (such as media playback application 112 or browser-based media player 114) executed by streaming client 102. In one embodiment, media server 104 may send code, such as a Javascript routine, to be executed by streaming client 102 for obtaining advertising content.

In response to the signal for advertising 206, streaming client 102 may send a request for advertising content to ad server 108, as indicated at 208. Ad server 108 may respond to the request for ad content 208 by streaming ad content to streaming client 102, as indicated at 210. One or more ad verifiers may be included in the ad content stream. Alternatively, ad verifiers may be provided from ad server 108 to streaming client 102 before or after sending ad content. Streaming clients with ad-blocking modifications may not request ad content, bypassing 208, or may respond to the signal for advertising 206 by requesting substitute content from a server that is not an advertising server.

In some embodiments, streaming client 102 may request media content after receiving ad content from ad server 108, as indicated at 212. Media server 104 may request information associated with the one or more ad verifiers that streaming client 102 received from ad server 108, as indicated at 214. Streaming client 102 may respond to the request 214 by sending information associated with the one or more ad verifiers to media server 104, as indicated at 216. The information associated with the one or more ad verifiers may include one or more of a signature, a hash of part or all of the advertising stream provided at 210, a session identifier, a streaming client identifier, a timestamp, a cryptographic nonce, or combinations thereof (such as a concatenation of a timestamp, a nonce, and a streaming client identifier).

When media server 104 receives the information associated with the ad verifiers, media server 104 may use the information associated with the ad verifiers to validate streaming of advertising content to streaming client 102, which was indicated at 210 above. If media server 104 determines that advertising content was downloaded by streaming client 102, media server 104 may stream media content to streaming client 102, as indicated at 218. If media server 104 determines that advertising content was not downloaded by streaming client 102, media server 104 may halt streaming media content to streaming client 102.

FIG. 3 shows illustrative components that may be included in an ad verifier 300. Ad verifier 300 may include one or more of a session identifier 302, a body specifier 304, and a digital signature 306. Ad verifier 300 may be generated by ad server 108. Ad verifier 300 may be included in a file, such as a multimedia file having an International Organization for Standardization (ISO) Base Media File Format (BMFF) described in ISO/IEC 14496-12 or derived specifications (such as the 3GP file format described in 3GPP Technical Specification 26.244). ISO BMFF defines a structure for media files. A media file formatted using ISO BMFF may include one or more free space boxes. Free space boxes may contain information that is irrelevant to media playback. One or more ad verifiers may be stored in a free space box. In one embodiment, advertising content may be sent in a file formatted as defined by ISO BMFF and one or more ad verifiers may be stored in one or more free space boxes in the file.

An ad verifier 300 may be inserted at the beginning, end, and/or within an advertising stream. Ad verifiers 300 may be located periodically or at random or irregular intervals within the ad content. In some embodiments, ad verifiers associated with an advertising stream may be sent separately from the advertising stream. Ad verifiers may be transmitted via a platform-based communication channel, such as a browser. For example, ad verifiers may be sent to streaming client 102 and retrieved by media server 104 using a browser cookie. In another example, a locally stored object (LSO) as defined in the Adobe Flash media player platform may be used to communicate ad verifiers between the ad server 108, streaming client 102, and media server 104. It will be recognized that other file formats and/or communication approaches may be used for sending ad verifiers 300 from ad server 108 to streaming client 102. Streaming client 102 may send information associated with ad verifier 300 to media server 104 so that media server 104 can verify that streaming client 102 downloaded advertising content from ad server 108. Information associated with ad verifier 300 is also referred to as “verification information” herein.

Session identifier 302 may include one or more of a timestamp 308, a nonce 310, and streaming client identifier 312. In some embodiments, media server 104 may use timestamp 308 for validating information associated with an ad verifier 300 received from streaming client 102. For example, media server 104 may require that information associated with an ad verifier include a timestamp that falls within a predefined window of time, such as 120 seconds, from a timestamp value. It will be recognized that other time window definitions can be used to define periods of time spanning seconds, minutes, hours, etc. If a timestamp provided by streaming client 102 to media server 104 does not fall within the time window, media server 104 may determine that the verification information received from streaming client 102 is not valid and may halt streaming of media content to streaming client 102. For example, if an ad verifier 300 has a timestamp 308 of “Aug. 1, 2012 13:30:05” and the valid time window is 120 seconds, then verification information submitted to media server 104 between “Aug. 1, 2012 13:30:05” and “Aug. 1, 2012 13:32:05” may be successfully validated by media server 104. In this manner, streaming client 102 may be prevented from using verification information generated for advertising content that was not recently downloaded by streaming client 102 (e.g., verification information generated by another streaming client at an earlier time).

In some embodiments, session identifier 302 may include a nonce 310 and a timestamp 308. For example, a binary representation or text associated with a nonce may be concatenated a binary representation or text associated with session identifier 302. Nonce 310 may be a random number or a pseduo-random number. Nonce 310 may be used to prevent replay attacks. In this manner, a different nonce 310 may be generated by ad server 108 for each ad verifier 300 to prevent streaming client 102 from using verification information generated by another streaming client or generated at another time. Verification information containing a valid nonce may be successfully validated by media client 104. In some embodiments, the nonce may only be successfully validated if it is used within a valid time window relative to a timestamp.

A sequence number may be used in lieu of or in addition to a timestamp in session identifier 302. The sequence number may be generated by ad server 108. For example, ad server 108 may iterate the sequence number for each ad verifier sent in all ad streams or for each ad verifier sent in a particular ad stream. In this manner, each ad verifier received by streaming client 102 may be sequenced such that streaming client 102 is prevented from reusing verification information from different ad verifiers. Verification information containing a valid sequence number may be successfully validated by media client 104.

Session identifier 302 may include a streaming client identifier 312. The streaming client identifier can be any information usable to identify a streaming client 102, such as IP address, a combination of IP address and port number, or other identifying information. A streaming client identifier 312 can be used to prevent verification information generated by another streaming client from being used by streaming client 102 for validation that advertising content has been downloaded. Verification information containing a correct streaming client identifier may be successfully validated by media client 104.

Ad verifier 300 may include a body specifier 304. In some embodiments, body specifier 304 includes byte range 314. Byte range 314 can indicate one or more parts or all of the advertising content. For example, a byte range of 100-200 can indicate the data stored in bytes 100-200 of the advertising content. When a byte range 314 is specified in body specifier 304, streaming client 102 may be required to perform a hash of the data indicated by the byte range and include the hash in the verification information to be provided to media server 104. In some embodiments, body specifier 304 may be null. When body specifier is null, streaming client 102 may provide verification information that does not include a hash to media server 104.

Ad verifier 300 may include digital signature 306. Digital signature 306 may be generated by ad server 108 using a cryptographic key stored by ad server 108. When body specifier 304 is null, digital signature 306 may be generated using information associated with session identifier 302, such as timestamp 308, nonce 310, and/or streaming client identifier 312. Digital signature may 306 may be produced by encrypting some or all of this information with the cryptographic key. When body specifier 304 indicates a byte range 314, digital signature 306 may be generated by ad server 108 using information associated with session identifier 302 and/or a hash of the advertising content data associated with the indicated byte range. In a preferred embodiment, a shared secret key is used to produce a digital signature based on a hash of the advertising content data.

FIG. 4 is an illustrative flow diagram for verifying that ad content has been downloaded by a streaming client, according to an embodiment. At operation 402, ad server 108 and media server 104 establish a cryptographic key relationship. For example, ad server 108 may generate a shared secret key and send the shared secret key to media server 104. Alternatively, ad server 108 may generate a public-private key pair and send the public key to media server 104.

At operation 404, media server 104 may receive a request for media content from streaming client 102. At operation 406, media server 104 may stream media content to streaming client 102. At operation 408, media server 104 may signal streaming client 102 to request advertising content from ad server 108. In some embodiments, streaming client 102 may request and receive advertising content from ad server 108 prior to requesting and receiving media content form media server 104 (i.e., operations 404-406 can be optional operations).

Streaming client 102 can receive advertising content from ad server 108. One or more ad verifiers 300 may be sent with the advertising content. Ad verifier 300 may include a digital signature 306. Streaming client 102 may generate verification information based on the one or more ad verifiers 300. Media server 104 may receive the verification information from streaming client 102, as indicated at operation 410.

Media server 104 may use the verification information received from streaming client 102 to validate streaming of the advertising content to the streaming client 102 (i.e., determining whether advertising content was downloaded by streaming client 102), as indicated at operation 412. For example, when verification information includes digital signature 306, media server can use the key it received from ad server 108 at operation 402 to verify the digital signature. When verification information includes session identifier information 302, media server 104 can check the session identifier information. At decision diamond 414, it is determined by media server 104 whether the verification information received from streaming client 102 indicates that streaming client 102 downloaded advertising content from ad server 108. If the download of advertising content is validated, media server 104 can continue to stream media (or can initiate streaming media) to streaming client 102, as indicated at operation 416. If the download of advertising content is not validated, media server 104 may discontinue streaming media to streaming client 102, as indicated at operation 418. In some embodiments, steps 408 through 418 may be repeated one or more times during delivery of a media stream.

Typically, if streaming client 102 is signaled by media server 104 to request advertising content and streaming client 102 subsequently fails to provide information associated with ad verifiers, media server 104 will discontinue streaming of media content to streaming client 102.

When multiple ad verifiers are delivered to streaming client 102 from ad server 108, media server 104 may prevent streaming of media content to streaming client 102 until all (or, in some embodiments, a subset) of the ad verifiers have been validated.

FIG. 5 is an illustrative flow diagram for verifying that ad content has been downloaded by a streaming client 102 when a byte range 314 is specified in an ad verifier 300. At operation 502, ad server 108 and media server 104 establish a cryptographic key relationship. For example, ad server 108 may generate a shared secret key and send the shared secret key to media server 104. Alternatively, ad server 108 may generate a public-private key pair and send the public key to media server 104. In an embodiment, the ad server 108 may send the shared secret key using a secure protocol, e.g., sending the key with a certificate that may be used to authenticate the key.

At operation 504, streaming client 102 may request media content from media server 104. At operation 506, streaming client 102 may receive media content from media server 104. At operation 508, streaming client 102 may request advertising content from ad server 108. For example, streaming client 102 may receive a signal for ad from media server 104 as indicated at 206. In some embodiments, streaming client 102 may request and receive advertising content from ad server 104 prior to requesting and receiving media content form media server 104 (i.e., operations 504-506 can be optional operations).

At operation 510, streaming client 102 can receive advertising content from ad server 108. One or more ad verifiers 300 may be sent with the ad content. Ad verifier 300 may include a digital signature 306 and a specified byte range 314. Streaming client 102 may generate a hash based on the specified byte range 314, as indicated at operation 512. At operation 514, streaming client 102 may send verification information including the hash and the digital signature 306 to media server 104.

Media server 104 can apply the key it received from ad server 108 at operation 502 to the hash and compare the resulting value to digital signature 306, as indicated at operation 516. At decision diamond 518, media server 104 validates streaming of advertising content to streaming client 102 by determining whether the comparison of operation 516 results in a match. If the value resulting from applying the media server key to the hash matches digital signature 306, media server 104 can continue to stream media (or can initiate streaming media) to streaming client 102, as indicated at operation 520. If the resulting value does not match digital signature 306, media server 104 may discontinue streaming media to streaming client 102, as indicated at operation 522. In some embodiments, steps 508 through 522 may be repeated one or more times during delivery of a media stream.

FIG. 6 is an illustrative flow diagram for verifying that advertising content has been downloaded by a streaming client 102 with a browser-based media player 114. At operation 602, ad server 108 and media server 104 establish a cryptographic key relationship. For example, ad server 108 may generate a shared secret key and send the shared secret key to media server 104. Alternatively, ad server 108 may generate a public-private key pair and send the public key to media server 104. In an embodiment, the ad server 108 may send the shared secret key using a secure protocol, e.g., sending the key with a certificate that may be used to authenticate the key.

At operation 604, streaming client 102 may request media content from media server 104. At operation 606, streaming client 102 may receive media content from media server 104. At operation 608, streaming client 102 may request advertising content from ad server 108. For example, streaming client 102 may receive a signal for ad from media server 104 as indicated at 206. In some embodiments, streaming client 102 may request and receive ad content from ad server 104 prior to requesting and receiving media content form media server 104 (i.e., operations 604-606 can be optional operations).

At operation 610, streaming client 102 can receive ad content from ad server 108. One or more ad verifiers 300 may be sent to streaming client 102 in a browser cookie or an anonymous code. The browser cookie or the anonymous code may include a digital signature. Media server 104 may retrieve the one or more ad verifiers 300 from the browser cookie or the anonymous code, as indicated at 612. For example, streaming client 102 may send the browser cookie or the anonymous code to media server 104, or media server 104 may otherwise obtain the browser cookie or the anonymous code from streaming client 102. Media server 102 may parse the browser cookie or the anonymous code to obtain the ad verifiers 300.

Media server 104 can use the key it received from ad server 108 at operation 602 to verify a digital signature obtained from an ad verifier in a browser cookie or an anonymous code, as indicated at operation 616. At decision diamond 618, media server 104 validates streaming of advertising content to streaming client 102 by determining whether the digital signature can be verified. If the digital signature is verified, media server 104 can continue to stream media (or can initiate streaming media) to streaming client 102, as indicated at operation 620. If the digital signature is not verified, media server 104 may discontinue streaming media to streaming client 102, as indicated at operation 622.

In some embodiments, media playback on streaming client 102 may be performed using a media playback application such as the Adobe Flash media player platform. The Adobe Flash media player may run in browser 116 or as a standalone application, such as media playback application 112. Adobe Flash uses local shared objects (LSOs) to store data associated with a website or with the Adobe Flash application. For example, LSOs may be stored to a storage medium of streaming client 102 and obtained by media server 104. Ad verifiers may be sent to a client and retrieved from a client according to the flow described with reference to FIG. 5, using LSOs in lieu of browser cookies. In this way, if a user has configured browser 116 to block cookies, the LSO may still be used to deliver ad verifiers.

FIG. 7 is an illustrative block diagram of a computer system that may be used to implement any of the entities or components described above (e.g., client system 102, media server 104, and advertising server 108). The computer system may be implemented as a combination of hardware and software components, according to various embodiments. The computer system may comprise a set of instructions that can be executed to cause the system to perform any one or more of the methods discussed herein. The computer system may be realized as a specific machine in the form of a computer. The system may be a server computer, a personal computer (PC), or any system capable of executing a set of instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein.

The computer system may include the processor 702 (e.g., a central processing unit (CPU)), a memory 704 which may store program code during execution, and non-volatile storage 706, all of which communicate with each other via a bus 700. The system may further include a video display unit 708 (e.g., a liquid crystal display (LCD) or cathode ray tube (CRT)). The system also may include an alphanumeric input device 710 (e.g., a keyboard), and a network interface device 712 for receiving content source and delivering content store.

The non-volatile storage unit 706 may include a machine-readable medium on which may be stored one or more sets of instructions (e.g., software) embodying any one or more of the methodologies or functions described herein. The instructions may also reside, completely or at least partially, within the memory 704 and/or within the processor 702 during execution thereof by the system, with the memory 704 and the ingestion processor 702 also constituting machine-readable media.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. In some cases, the software components can be provided on tangible, non-transitory media for execution on hardware that is provided with the media or is separate from the media. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A processor-implemented method comprising:
requesting, by a streaming client, advertising content from an advertising server;
receiving, from the advertising server, one or more verifiers; and
sending, to a media server, information associated with the verifiers, wherein the media server is configured to validate streaming of the advertising content to the streaming client based on the information associated with the verifiers.

2. The method of claim 1, wherein a verifier includes a digital signature based on a shared secret cryptographic key, wherein the shared secret cryptographic key is stored by the advertising server and the media server; and
wherein validating streaming of the advertising content to the streaming client is further based on the shared secret cryptographic key.

3. The method of claim 1, wherein:
a verifier includes a digital signature based on a public-private cryptographic key pair;
a private cryptographic key of the public-private cryptographic key pair is stored by the advertising server;
a public cryptographic key of the public-private cryptographic key pair is stored by the media server; and
wherein validating streaming of the advertising content to the streaming client is further based on the public cryptographic key.

4. The method of claim 1, wherein the verifier includes at least one of a session identifier, a body specifier, and a digital signature.

5. The method of claim 4, wherein a session identifier includes at least one of a timestamp, a nonce, and a client identifier.

6. The method of claim 4, wherein a body specifier includes a byte range; and wherein the client generates a hash of the data corresponding to the byte range.

7. The method of claim 1, wherein a verifier is included in a free space box of a media file formatted according to an ISO Base Media File Format.

8. The method of claim 1, wherein the verifiers are located at random locations within an advertising stream.

9. The method of claim 1, wherein a verifier is received from the advertising server in a browser cookie.

10. The method of claim 1, wherein a verifier is received from the advertising server in a locally stored object.

11. Non-transitory computer readable media for storing program code executable by a processor of a streaming client, the program code comprising:
program code for requesting advertising content from an advertising server;
program code for receiving, from the advertising server, one or more verifiers; and
program code for sending, to a media server, information associated with the verifiers, wherein the media server is configured to validate streaming of the advertising content to the streaming client based on the information associated with the verifiers.

12. The non-transitory computer readable media of claim 11, wherein the verifier includes at least one of a session identifier, a body specifier, and a digital signature.

13. The non-transitory computer readable media of claim 12, wherein a session identifier includes at least one of a timestamp, a nonce, and a client identifier.

14. The non-transitory computer readable media of claim 12, wherein a body specifier includes a byte range; further comprising program code for generating a hash of the data corresponding to the byte range.

15. A client device comprising:
a memory; and
a processor coupled to the memory, the processor configured with processor-executable instructions to perform a method comprising:
requesting advertising content from an advertising server;
receiving, from the advertising server, one or more verifiers; and
sending, to a media server, information associated with the verifiers, wherein the media server is configured to validate streaming of the advertising content to the streaming client based on the information associated with the verifiers.

16. The client device of claim 15, wherein the verifier includes at least one of a session identifier, a body specifier, and a digital signature.

17. The client device of claim 16, wherein a session identifier includes at least one of a timestamp, a nonce, and a client identifier.

18. The client device of claim 16, wherein a body specifier includes a byte range; further comprising program code for generating a hash of the data corresponding to the byte range.

19. A processor-implemented method, comprising:
sending, by a media server, streaming media to a streaming client;
receiving, from the streaming client, information associated with one or more verifiers, wherein the verifiers are associated with advertising content; and
validating streaming of the advertising content to the streaming client based on the information associated with the verifiers, wherein if the validation is unsuccessful, the sending of the streaming media is halted.

20. The method of claim 19, wherein a verifier includes a digital signature based on a shared secret cryptographic key, wherein the shared secret cryptographic key is stored the media server and by an advertising server that provides the advertising content; and
wherein validating streaming of the advertising content to the streaming client is further based on the shared secret cryptographic key.

21. The method of claim 19, wherein:
a verifier includes a digital signature generated using a private cryptographic key of a public-private cryptographic key pair;
the private cryptographic key of the public-private cryptographic key pair is stored by an advertising server that provides the advertising content;
a public cryptographic key of the public-private cryptographic key pair is stored by the media server; and
wherein validating streaming of the advertising content to the streaming client is further based on the public cryptographic key.

22. The method of claim 19, wherein the information associated with the verifiers includes a signature and a hash of at least part of the data corresponding to the advertising content, wherein validating streaming of the advertising content includes applying the public cryptographic key to the hash to obtain a resulting value and comparing the resulting to the signature.

23. The method of claim 19, wherein validating streaming of the advertising content includes validating a digital signature contained within a browser cookie.

24. The method of claim 19, wherein validating streaming of the advertising content includes validating a digital signature contained within a locally stored object.
